(19) United States
(12) Patent Application Publication
(10) Pub. No.: US 2009/0061980 A1
(43) Pub. Date: Mar. 5, 2009

(54) Method and Devices for Increasing Player Interaction in a Game

(75) Inventors: Charles Holton, Alpharetta, GA (US); Mark G. Meyer, Cumming, GA (US)

Correspondence Address: DORITY & MANNING, P.A., POST OFFICE BOX 1449, GREENVILLE, SC, 29602-1449, US

(73) Assignee: Scientific Games International, Inc., Newark, DE (US)

(21) Appl. No.: 12/199,510

(22) Filed: Aug. 27, 2008

Related U.S. Application Data
(60) Provisional application No. 60/968,729, filed on Aug. 29, 2007.

(51) Int. Cl. A63F 3/06; A63F 9/24; B42D 15/00; A63F 13/12

(52) U.S. Cl. 463/17; 283/100; 463/42; 273/139

(57) ABSTRACT

New methods of conducting games are provided that allow for a more interactive experience for the player so as to increase player participation. New methods of conducting a lottery as well as new games (for example, new playing cards) that may be used with such methods are disclosed. Both predetermined and random results may be included in versions of the present inventive methods and, in a preferred embodiment, the new lottery game combines instant results with subsequent results determined by one or more drawings.

### PRIORITY CLAIM

The present application claims priority to U.S. Provisional Application Ser. No. 60/968,729, filed Aug. 29, 2007.

### BACKGROUND OF THE INVENTION

Lottery games have been previously conducted by providing lottery tickets at retail establishments that provide for either instant outcome determinations or results that are determined by a drawing conducted subsequent to the purchase of the lottery ticket. For example, a player may purchase a ticket at a retail establishment and play the card instantly by scratching off removable material to determine whether a prize has been won. Alternatively, the player may purchase a ticket having a number that is entered into a subsequently conducted drawing. One or more drawings are conducted on subsequent dates to determine winners. Results may be announced, for example, on television or radio.

For the instant ticket example, the game lasts only until the player removes the material from the ticket to determine the final outcome. As such, the player has limited interaction in a game experience that is relatively short. For the ticket used in a subsequent drawing, the player must wait until the drawing is conducted to determine the only and final outcome and must learn such results by receiving the television or radio broadcast at the time of transmission (or by recording the broadcast and viewing later). Accordingly, other than waiting for, and then viewing or listening to the drawing broadcast, the player has no interaction with the drawing results in playing the game.

### SUMMARY OF THE INVENTION

Objects and advantages of the invention will be set forth in part in the following description, or may be obvious from the description, or may be learned through practice of the invention.

The present invention provides a new lottery game that creates a more interactive experience for the player. New methods of conducting a lottery as well as new games (for example, new playing cards) that may be used with such methods are disclosed. Both predetermined and random results may be included in versions of the present inventive methods and, in a preferred embodiment, the new lottery game combines instant results with subsequent results determined by one or more drawings.

A summary of an exemplary method according to the present invention is illustrated in FIG. 1A. In an initial step 10, a game card is provided to a player such as when a player purchases a game card or ticket at a retail establishment or electronically over a computer network such as the Internet. In step 20, the player is allowed to select a particular lottery drawing in which to enter the game card for play. As shown by step 15, multiple lottery drawings are conducted as determined by the lottery provider and are available for play. The player is allowed to select a particular drawing—perhaps at a time convenient to the player—for entry and play of the game ticket (In a variation of the invention, the particular lottery drawing in which the game card will be played is automatically assigned at the time the game card is provided to the player). Once the drawing is conducted, the result of the particular lottery drawing selected by (or for) the player is revealed to the player. The revealing step 30A may be “live” in that it occurs about the same time as the lottery drawing is conducted. Alternatively, the revealing step 30B may be delayed in that the lottery results are available for the player to view at some time after the lottery drawing has been conducted and at a time of the player's choosing. The lottery results are preferably provided in an interactive format that allows the player to control features such as the speed at which the results are viewed and instant replay of the results. For certain games, the lottery results may also include not only the information necessary for the player to determine the player's individual results but information about the winnings of other players may also be provided such as the size of the winnings by other players and an identification of the draws (i.e. on the “15ₜₕ draw”) when such winnings occurred. Such information may be provided and updated as the results are reported to the player so as to increase the excitement of the game by creating a “live” context for the player.

Accordingly, in another exemplary method of the present invention, a method for increasing player interaction in a game is provided that includes the steps of providing at least one game card to a player, conducting a plurality of lottery drawings at different times with each drawing being suitable for play with the game card, allowing the player to select from the plurality of lottery drawings a particular lottery drawing in which the game card will be played, and revealing to the player the results of the particular lottery drawing selected by the player. The revealing step may occur about the same time as the particular lottery drawing selected by the player is being conducted or may occur after the particular lottery drawing selected by the player has been conducted and wherein at a time chosen by the player. The revealing step may include transmitting the results of the particular lottery drawing to the player over a computer network. Where the game card comprises a plurality of game indicia, the revealing step may include displaying the plurality of game indicia to the player.

For this exemplary method, the player may be allowed to control the pace at which the results of the particular lottery drawing are reported to the player during the revealing step. The game card may have an instant win portion that can be played upon purchase of the game card and/or may have a lottery-dependent portion that the player can play only in conjunction with said revealing step. The method may require that the instant win portion and the lottery-dependent portion be combined to determine the game results for the player. The method may allow multiple players to participate in each drawing and provide for reporting the total number of participating players to each player and/or information regarding wins by other players. Furthermore, if desired, the size of potential winnings available to a player may be determined in part on the number of the other players. This exemplary method may also allow the player to select more than one drawing in which the game card will be played. Each lottery drawing may have a finite number of draws—i.e. a finite number of indicia that will be drawn. Alternatively, depending upon the game being played and/or the lottery provider's preferences, each lottery drawing may be continued until at least one win is identified among entered gamed cards or participating players.

Furthermore, for this exemplary method, the time at which the player may be allowed to select from the plurality of lottery drawings can be varied. For example, this selection may occur at the point of sale of the game card or the player may be allowed to make this selection at some time after the point of sale. In addition, the player may be limited to only one game card or may be provided with a plurality of game cards that the player can enter into one or more lottery drawings as selected by the player. Where multiple game cards are played, the player may be allowed to view simultaneously the plurality of game indicia of more than one entered game card during the revealing step. The revealing step may also allow the player to replay the lottery drawing such as e.g., an instant replay feature.

As already stated, the new methods of conducting a lottery described herein may be applied to both existing and new games as well. For example, in one exemplary method, a method for increasing player interaction in a game is provided that includes the steps of providing at least one game card to a player, conducting a lottery drawing, and reporting the results of the lottery drawing to the player. The game card includes a player indicia area containing a plurality of player indicia, the player indicia being hidden by a cover that is removable by the player. The game card also includes a game indicia area containing a plurality of game indicia arranged into columns and rows so as to form a grid on the game card. The player indicia and game card indicia are configured such that the player can have an instant win by matching player indicia with game indicia to form one or more lines along a column, row, or diagonal of the grid of game indicia. The player can also win by matching the results of the lottery drawing with game indicia to form one or more lines along a column, row, or diagonal of the grid of game indicia.

Additionally, in another exemplary method, a method for increasing player interaction in a game is provided that includes the steps of providing at least one game card to a player, conducting a lottery drawing, and reporting the results of the lottery drawing to the player. The game card includes a player indicia area containing a plurality of player indicia, the player indicia being hidden by a cover that is removable by the player, the player indicia being selected from a set of player indicia and organized into a grid of columns and rows. The game card also includes a multiplier indicia area containing at least one indicia selected from a set of multiplier indicia. The player indicia are configured such that the player can have an instant win by removing the cover to reveal a winning combination of player indicia within one of the rows in the grid of player indicia. The player can also win or increase the size of the win by matching the results of the lottery drawing with the multiplier indicia.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1A is a schematic illustration of the steps according to an exemplary method of the present invention.

FIG. 1B is a schematic illustration of the steps according to another exemplary method of the present invention.

FIG. 2A is an illustration of an exemplary embodiment of a playing card according to the present invention.

FIG. 2B is an illustration of an exemplary embodiment of an interactive video screen that may be used to play a game according to the present invention.

FIG. 3 is another illustration of an exemplary embodiment of a playing card according to the present invention.

FIG. 4 is another illustration of an exemplary embodiment of a playing card according to the present invention.

### DETAILED DESCRIPTION

Reference will now be made in detail to embodiments of the invention, one or more examples of which are illustrated in the figures. Each example is provided by way of explanation of the invention, and not meant as a limitation of the invention. For example, features illustrated or described as part of one embodiment can be used with another embodiment to yield a third embodiment. It is intended that the present invention include these and other modifications and variations.

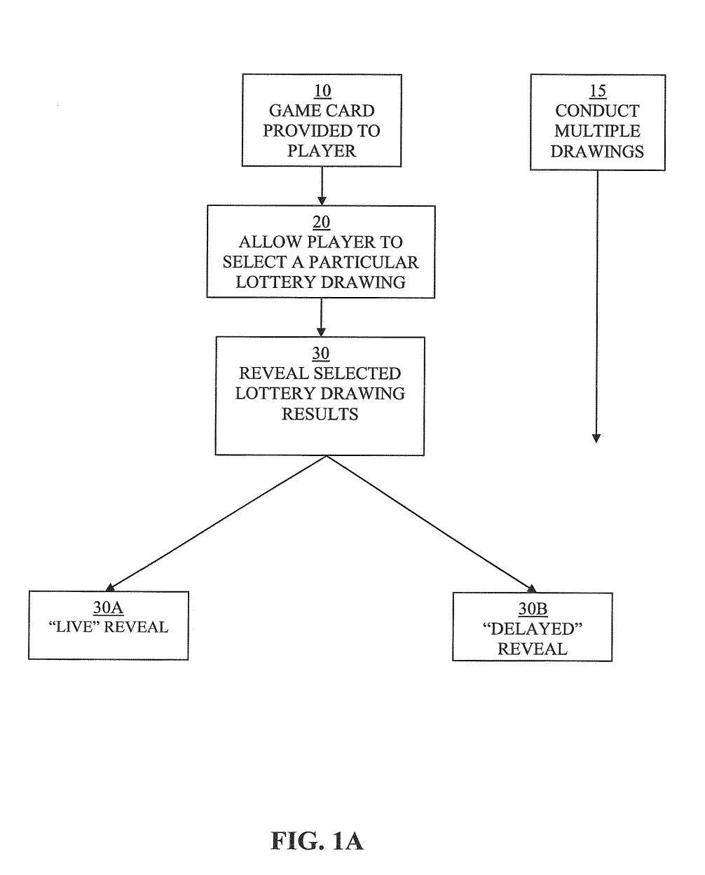

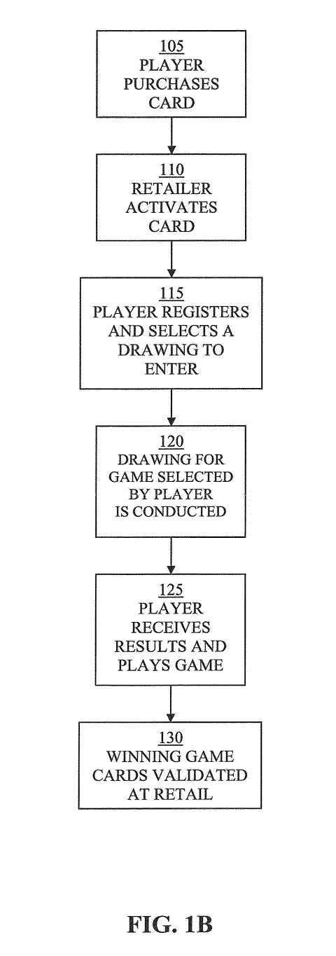

FIG. 1B illustrates an exemplary method according to the present invention. As shown, in an initial step 105, a player is provided with at least one game card such as, for example, when the player purchases a game card for the lottery game. Preferably, the game card is preprinted on a substrate provided with indicia for playing one or more games, examples of which are described below. The game card may be purchased, for example, at a retail establishment. Other embodiments of the game card may be used with the present invention and such include electronic versions of the game card that could be purchased and delivered by various methods such as electronic mail (e-mail), Internet delivery, and/or transmission to an electronic device. In certain embodiments of the invention, the player may be allowed to purchase more than one game card for play and allowed to enter the cards in one or multiple drawings. For purposes of discussion only, the present exemplary method will be discussed with reference to a single game card.

As will be described with reference to an exemplary game discussed below, the game card purchased by the player may have an instant game (or instant win) aspect in addition to an aspect that is dependent upon the results of a lottery drawing such as a drawing conducted subsequent to the time at which the player is provided with the game card. For example, the card may provide a game or indicia that allows for an instantaneous result that is played separately and/or in combination with the results of a lottery drawing. A bonus area may, for example, provide an immediate multiplier should the player win the lottery drawing and/or may provide an instant minimum amount won as a predetermined result provided on the game card.

In step 110, a retailer activates the game card. Activation may include transmitting a code printed onto the substrate to a lottery provider to record that the card has been purchased and is in the possession of a player. For example, a bar code may be read by a scanner that is connected to the lottery provider through a network so that the provider is notified that the card is now in play. Alternatively, and by way of example, activation could also include having the purchaser/player transmit an activation code to the lottery provider. In still another form of the invention, the activation step may be omitted where unnecessary or not required for conducting a particular game or lottery.

Next, in step 115, the player registers the game card by selecting a particular lottery drawing in which to enter the game card. In a preferred embodiment of the present invention, the lottery provider conducts multiple lottery drawings from which the player may select a particular lottery drawing in which to enter the game card (or multiple drawings if more than one card is being played). For example, the lottery provider may provide the results of a lottery drawing at the beginning of each hour of the day (e.g. 1 PM, 2 PM, 3 PM, etc.) or may choose some other scheduling for providing the drawing results. Regardless of the actual schedule selected by the provider, in this exemplary embodiment of the present invention, the player has an opportunity to choose from multiple times at which either a lottery drawing will be conducted or the results of different drawings will be available. As such, the player is allowed to select a lottery drawing time convenient to the player's schedule or otherwise of the player's choosing. In an alternative exemplary embodiment of the present invention, the player may purchase a game card that is assigned at the point of sale to a subsequent, specific time at which either the lottery drawing will be conducted or the results of a drawing will be provided. For example, the player may purchase a particular card that is valid for a lottery drawing scheduled to occur at some predetermined time subsequent to the time of sale or card activation. Registration may also allow the lottery provider to determine various aspects of the drawings such as the number of players participating in each draw, the identity of the cards that will be in play during a particular drawing, and/or the amount of the winnings available to the players.

In step 120, the lottery provider conducts a drawing for the lottery game related to the game card purchased by the player and the drawing time selected by the player. Depending upon the particular game for which the lottery drawing is being conducted, the present invention includes multiple variations for step 120. For example, in one exemplary embodiment of the present invention, at a predetermined time the lottery provider conducts a drawing of a predetermined number of indicia without regard to whether the particular drawing has resulted in a winner among the player cards that were registered for the particular drawing. In such case, the lottery provider may allow such cards to be used again in one or more additional drawings until one or more winners is generated. By way of further example, the lottery provider may conduct draws of game indicia for a particular drawing time until one or more winners among the activated game cards registered for that particular drawing has been generated. Such may be determined, for example, through comparison of the drawing results with the record of activated game cards created in step 110.

In step 125, the results of the particular lottery game selected by the player are revealed by e.g., the lottery provider and the player receives the lottery results and plays the game in step 125. As with the other exemplary steps discussed above, the present invention includes multiple variations for step 125. By way of example, the revealing step may include providing the player with the lottery drawing results at about the same time the drawing is conducted. Alternatively, the results of the lottery drawing may be recorded or stored and revealed to the player at a time of the player's choosing.

The player may receive the lottery drawing results over the Internet (or other computer network) through an interactive website or client software loaded on the player's computer. Such results may also be provided to a mobile electronic device such as a cell phone or PDA. Again, the results of the lottery drawing may be provided live as the draw takes place such that player receives each draw result about the same time as it is conducted in step 120. Alternatively, the results of the entire, previously conducted drawing may be provided to the player at a time convenient to the player. Using Internet delivery as an example, an encrypted file may be provided to the player's electronic device once the player has registered, selected a game, and the drawing has been conducted. The player's electronic device may then allow the player to select not only the time at which the results of the lottery will be viewed but even control the speed at which the player sees the results of the drawing. For example, the player may be allowed to enter a prompt whenever the player is ready to see the next drawn indicia. The player may also be able to repeat all or part of the draw to “relive” or “replay” the game experience at the player's choosing. Where the results of the lottery are reported to the player after the entire drawing has been conducted, the player may also receive information about other players such as the number of winners, amount of winnings, the time during the drawing (i.e. the draw number) such wins occurred. In addition, to simulate a live event such information and results may be delivered in a format that updates during each successive draw as the player receives the results of the lottery drawing.

In another alternative of the present invention, the results may be provided in a less interactive manner such as by a video screen in a retail establishment. For example, the results of the drawing may simply be broadcast at a particular time after the player has purchased the game card.

Finally, in step 130, the player redeems a winning game card. For example, the player may return a winning game card to the retail establishment where it was purchased or to a lottery provider to collect the prize. As previously mentioned, the game card may provide for multiple prizes or chances to win through predetermined results and/or based on the lottery drawing results. Various exemplary embodiments of lottery games including game cards according to the present invention will now be described. Each of these game cards and others may be used with the exemplary methods of the present invention to provide more interactive gaming experience and thereby increase a player's involvement and interest in the game.

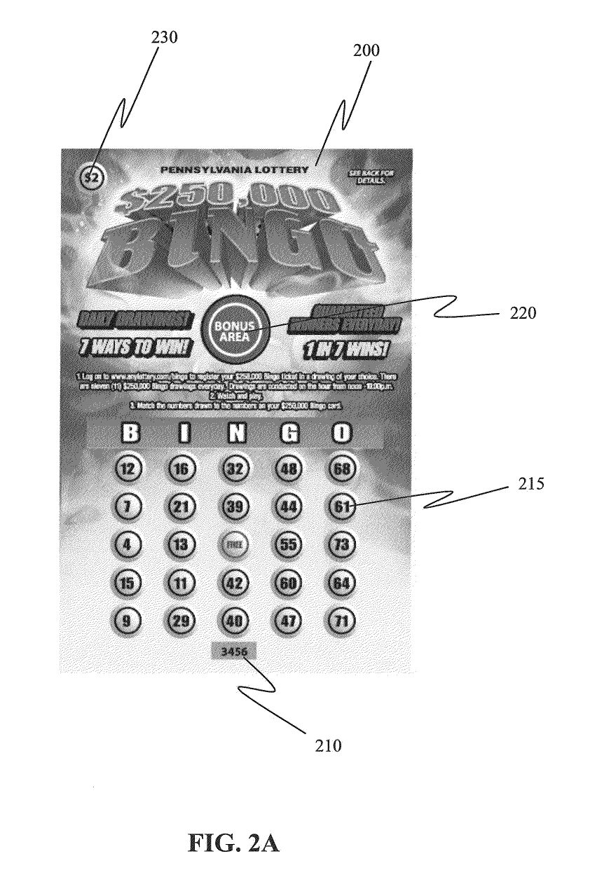

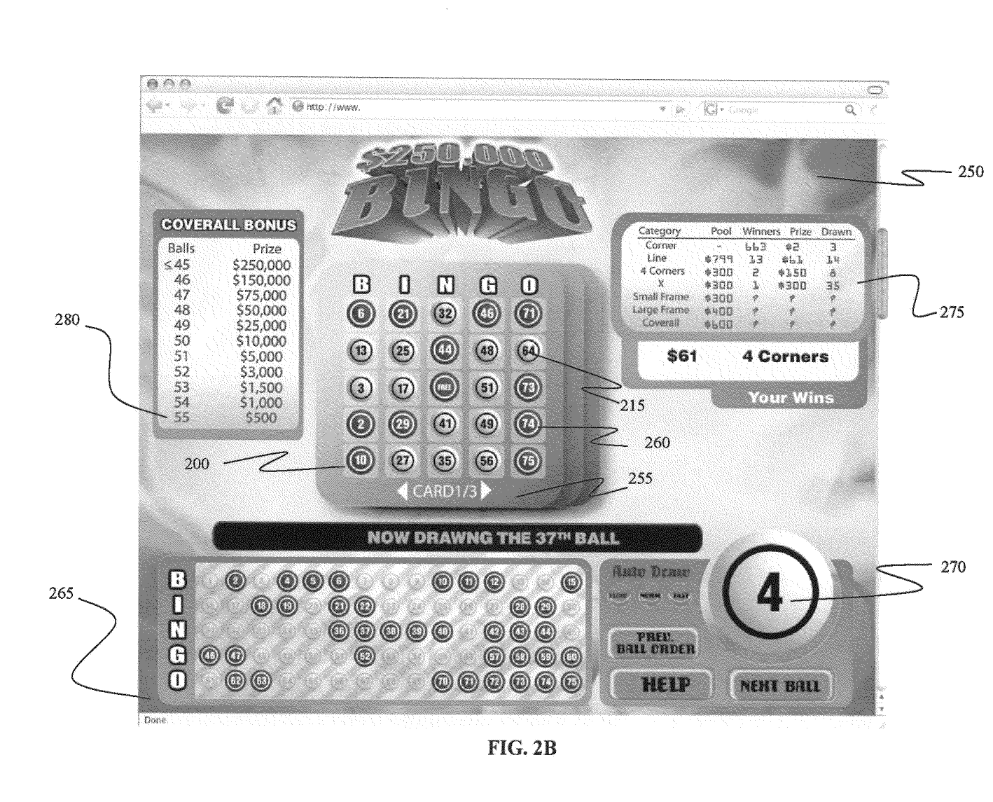

FIG. 2A provides a game card 200 in accordance with an exemplary embodiment of a lottery game of the present invention. Upon purchase, card 200 is activated by entry of a unique identification code located, for instance, on the back (not shown) of card 200. For example, this may include scanning entry of a bar code into the lottery provider's database of active player cards. Prize tables, instructions, a signature area, and other information may also be placed on the back of card 200. The front of the card, as shown in FIG. 2A, includes indicia for the price of the card 230, a bonus area indicia 220 (which generally includes a coating as shown that is removable by the player), game indicia 215, and unique registration code indicia 210 (which may also be covered by a removable coating).

As mentioned previously, at the time of purchase and activation, the game card 200 may be simultaneously registered for a drawing scheduled for a time subsequent to the purchase, or the card 200 could be registered by having the player submit the registration code at an online lottery terminal. Alternatively, in a preferred form of the invention, the player uses the unique registration code 210 to register for a lottery drawing conducted at a time of the player's choosing. More specifically, the player selects at his discretion from multiple drawing times scheduled by the lottery provider. The player may make this selection at the time the game card is provided (e.g., at the point of sale) or at some subsequent time selected at the discretion of the player.

For example, in one exemplary method of using game card 200, the player downloads and executes game client software from a lottery provider's website or some other website for use with the game. This software might be downloaded to the player's computer, cell phone, or some other electronic device. Using this software, the player then enters the registration code 210 in the game client software interface to register playing card 200 for a drawing time selected by the player. The game client then transmits the registration code 210 to an Internet game server that is connected to the online lottery system. The game server in turn transmits the registration code 210 to the online lottery system.

Upon receiving the registration code 210, the online lottery system retrieves a record of the game indicia that was preprinted on playing card 200 from a database of all the preprinted cards. The online lottery system transmits a record of the game indicia back to the Internet game server. Additional information may also be transmitted such as, for example, an identifier for the next scheduled drawing or an identifier confirming the drawing for which the player selected registration. The number of players currently registered for the game might also be transmitted. Where a rolling jackpot is used, the current amount of the jackpot might also be transmitted, for example. The online lottery system also adds the registration code 210 to the database of ticket identification codes of those tickets registered for a particular drawing.

The Internet game server assembles the data received from the online lottery system into a format suitable for the game client and transmits this information to the game client software interface downloaded by the player or otherwise available on the player's electronic device. The game client software then displays a video or virtual representation of the same game indicia as shown on the card 200 and a timer counting down to the time of the drawing. As shown in FIG. 2B, the format of the display may also include a game card the same or substantially similar in appearance to the actual card 200 provided to the player.

At the time of the scheduled drawing, the game client software then requests the outcome of the drawing from the Internet game server, which in turn assembles and formats the drawing outcome data and transmits this information to the game client software. Additional data may also be sent such as drawing data for displaying the drawing results and data specific to the player's card 200 such as the prize won.

FIG. 2B provides a representative drawing of the video image 250 provided to the player's electronic device by the game client interface software. Near the center of image 250, the same game indicia 215 appearing on the player's card 200 is displayed. Additional cards may also be played simultaneously and selectors 255 allow the player to toggle between such cards. Alternatively, multiple game cards entered by the player may all be displayed at the same time with results for each card being displayed as the results of the lottery drawings are revealed to the player. As the drawing is revealed by display to the player, the game client interface software automatically marks game indicia 215 as shown by marked game indicia 260. Draw indicia area 265 provides the player with an identification of all drawn indicia that have occurred at a particular point in the game while current indicia area 270 identifies the current drawn indicia to the player. Multiple other information areas can be provided on the screen as one of skill in the art will understand using the teachings disclosed herein. For example, game history area 275 provides the player with information about the number of winners and prize information relative to the number of draws. This information may be updated based as the player receives each draw result. For example, where if two winners occur on the sixth draw of the game, image 250 may include an area for reporting this information as the sixth draw is revealed to the player. Bonus area 280 informs the player of a bonus prize to be won for drawing all of the game indicia 215 on card 200. Other information and combinations thereof may also be provided such e.g., odds about the game that are updated as the lottery drawing results are revealed.

As such, using the game client software, this exemplary embodiment of the present invention provides the player with a more lively, interactive game than can be achieved with a card 200 that has an outcome that is instantly determined by, for example, scratching off various areas on the card. For example, the game client software formats and displays the drawing results as if the game indicia were being drawn sequentially in real time as the player views the screen. While the drawing may actually be conducted in real time while the player is viewing the screen, the present invention also allows the player to play the game subsequent to the actual time of the lottery drawing. More specifically, in the event the player is not actually on-line at the time of the transmittal from the Internet game server and/or the subsequent drawing, the transmittal is conveniently stored by the Internet game server and/or the player's game client software interface for viewing when the player is ready. Thus, while the online lottery system may conduct the lottery drawing instantaneously at the previously scheduled game time selected by the player and immediately transmit this information to the Internet game server, the player is also able to interact with the game at a time of his choosing. As such, although the lottery drawing may have actually occurred hours earlier, the results of the lottery are revealed to the player in a manner that simulates a “live” drawing is occurring as the player views the draw results and other information that can be updated as it is reported to the player.

In addition, the game client software can be configured to allow the player to control the speed at which the drawing is displayed by the game client, to allow the player to toggle between several tickets being played simultaneously, and/or to automatically mark the video representation of the game indicia 215 on the game card 200 as the drawn indicia 265 are displayed (as previously discussed). Also, the game client can be configured to allow players to replay past drawings in the same way in order to “relive” the drawing (such as a win) if desired. The game card 200 may have an instant win portion in area 220 that can be played both separately and/or in various combinations with the results of the lottery drawing and game indicia 215. Using the teachings disclosed herein, one of skill in the art will understand that other interactive features and combinations are within the scope of the present invention.

As shown in FIG. 2A, game card 200 is configured for a bingo game, the rules and variations of which will be familiar to one of skill in the art. Using the teachings disclosed herein, one of skill in the art will understand that the present invention resides not only with new applications of traditional games but also provides for new games that further increase player interactivity. Exemplary embodiments of such new games in accordance to the present invention will now be discussed by way of further description, and not limitation, of the present invention.

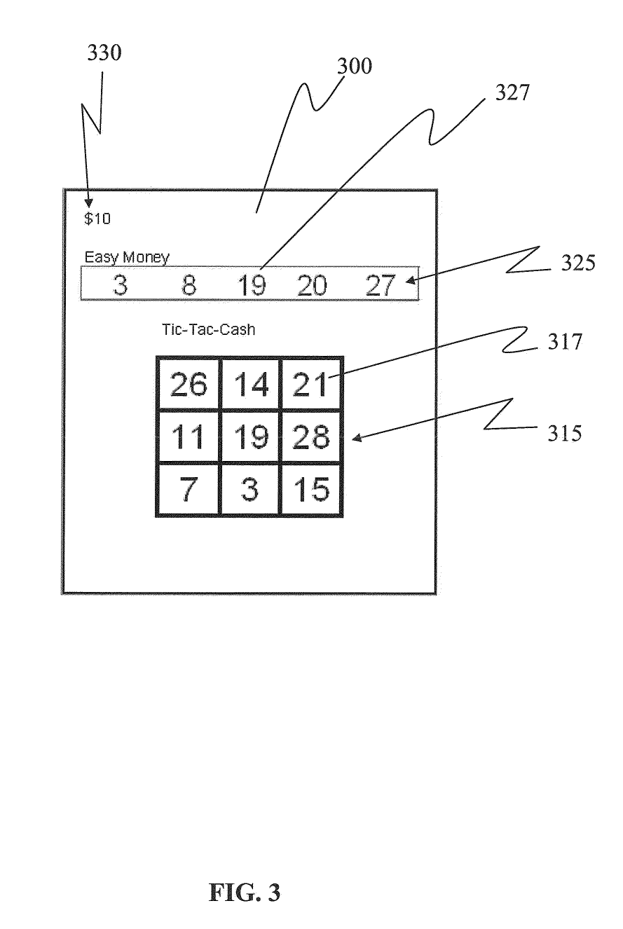

For example, FIG. 3 illustrates a game card 300 in an exemplary embodiment of the present invention. As will be understood, for the amount set forth by price indicia 330, game card 300 combines an instant win aspect of lottery games with a drawing conducted subsequent to the player's purchase of card 300. As shown in FIG. 3, player indicia area 325 has player indicia 327 comprising five numbers from the range of one to twenty-eight that are hidden under a removable cover such e.g., a removable coating (e.g., latex). In an electronic version of game card 300, one of skill in the art will understand that various techniques could be used to allow the player to selectively reveal or “uncover” player indicia 327. Game indicia area 315 has a grid of numbers (for this example, a 3×3 grid) that are provided as game indicia 317, which are also taken from the range numbers one to twenty-eight. Indicia 317 and 327 may be duplicative or mutually exclusive as desired by game designers depending on the game being played. While numbers are used in FIG. 3, it should be understood the present invention is not limited to the use of numbers as player indicia 327 or game indicia 317. By way of example only, letters, numbers, characters, and/or a variety of different symbols individually or in combination, may be used for player indicia 327 and game indicia 317.

Using game card 300, a player is provided with multiple different chances for winning. In the instant win aspect of the game, upon purchasing card 300, the player can immediately remove the material covering player indicia 327. The player can have an instant win by matching player indicia 327 with game indicia 317 to form one or more lines (horizontal, vertical, and/or diagonal) along the grid in game indicia area 315. Thus, game card 300 allows the player an instant win aspect without regard to the conduct of a lottery drawing. As used herein, “instant win” or “instant result” and the like refer not only to an instant prize award to the player but also includes an award of a multiplier, bonus, or other features that improve a player's odds or increase the player's win potential.

The player can also win using game card 300 through a lottery drawing aspect of the game. For example, in a manner as previously described, either at the time of purchase or later, game card 300 is registered for a drawing conducted subsequent to the time of purchase. With results provided also as previously described, the lottery drawing provides five additional draws, for example, numbers as used in the exemplary embodiment of FIG. 3. These five additional draws from the lottery may be used along with the five numbers 327 already provided on the face of card 300 in player indicia area 325 to attempt a match with game indicia 317 so as to form one or more horizontal, vertical, and/or diagonal lines in the grid of game indicia area 315. Each such line creates a win.

However, the game exemplified by card 300 can also be used to create additional winning opportunities. For example, wins can also be allowed where the player matches player indicia 327 with one or more of the numbers drawn in the lottery. The prize amount can be increased, for example, as the amount of such matches increases from one to five. The number of lines formed in the grid of game indicia area 315 can be used as a multiplier of the amount won by matching player indicia 327 with numbers from the lottery drawing. Where the player was not able to match any of the indicia 327 in player indicia area 325 with numbers from the lottery drawing, a prize can be awarded based on the number of lines formed in game indicia area 315 by matching indicia 317 with the five numbers from the lottery drawing. A grand prize may be awarded where a player matches all nine indicia in game indicia area 315. In all variations, the game may be played using a set number of draws or draws may be taken until a winner or set number of winners is determined.

One of skill in the art, using the teachings disclosed herein, will understand that the exemplary embodiment of the present invention using card 300 may be used to create multiple variations within the scope of the present invention. By way of example only, indicia other than numbers may be used, the size of the grid in game indicia area 315 may be changed, and the number of draws may be decreased or increased from five. Regardless, the game demonstrated with card 300 may be combined with the previously described methods as discussed above, for example, with card 200 to provide a more interactive lottery game. In addition, as with game card 200, an interactive display using features such as that described with regard to display 250 may be created for use in revealing the results of the lottery drawing to the player who entered game card 300.

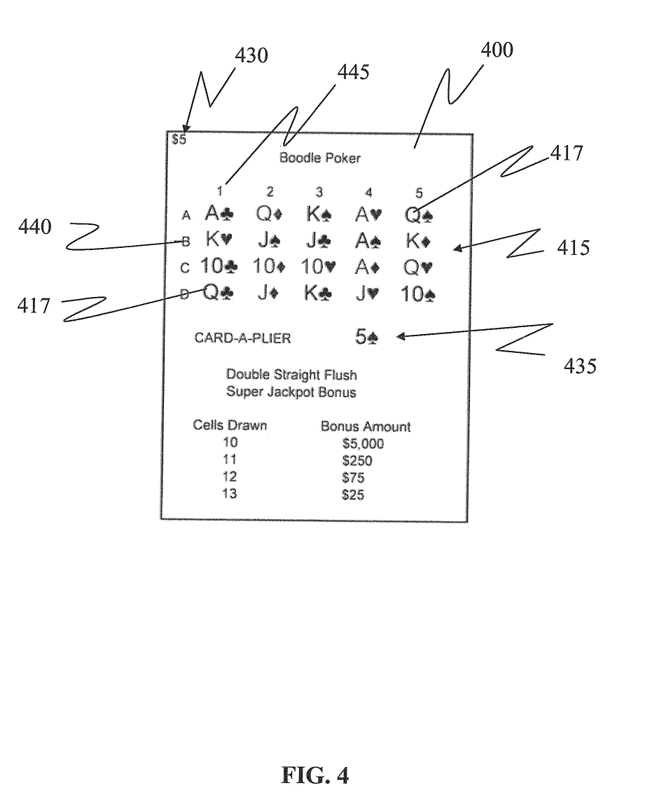

FIG. 4 illustrates a game card 400 in accordance with another exemplary embodiment of a lottery game of the present invention. The card has a price indicia 430, a player indicia area 415 with various indicia 417 taken from a deck of 52 playing cards or a subset thereof, and a multiplier card 435 also selected from a deck of 52 playing cards (where playing cards is understood as the traditional 52 card set comprising four suits with 13 cards each and, in variations of the game, other “wild” cards as might be added). For this exemplary embodiment, indicia 417 are covered by a coating that can be removed by the player after purchase to play the instant outcome (i.e., instant win aspect of the game). Card 400 can be registered for a lottery drawing conducted subsequent to the time of purchase according to one of the exemplary methods as previously described.

As with the embodiment of FIG. 3, game card 400 provides a game with both an instant result and a result that is determined in a lottery drawing. In the instant win aspect of the game (i.e., the part of the game that is determined from the face of the card without resort to the results of a lottery drawing), a player wins for each royal flush (A, K, Q, J, 10 of the same suit) formed in one of the four rows of five cards creating the grid in the player indicia area 415. In the lottery drawing part of the game, which can be conducted and delivered to the player using one of the exemplary methods as previously described (e.g., an interactive Internet site), a playing card is drawn randomly from a traditional deck of 52 playing cards. If the lottery draw results in a card that matches only the same suit as that of the card which is multiplier 435, then card 400 has a multiplier of 2 for any win that was created by forming a royal flush along a row of the player indicia area 415. In another variation of the invention, the multiplier could apply (as an alternative to, or in addition to, a win created by forming a royal flush) to any amount won elsewhere on card 400. If the lottery draw results in a card that matches only the same rank as that of the card which is multiplier 435, then card 400 has a multiplier of 5 for any win created by forming a royal flush along a row of the player indicia area 415. Again, in another variation of the invention, the multiplier could apply (as an alternative to, or in addition to, a win created by forming a royal flush) to any amount won elsewhere on card 400. If the lottery draw results in a card that matches the card of multiplier 435 (i.e., same rank and suit), then card 400 has a multiplier of 10 for any win created by forming a royal flush along a row of the player indicia area 415. As previously described, in another variation of the invention, the multiplier could apply (as an alternative to, or in addition to, a win created by forming a royal flush) to any amount won elsewhere on card 400.

Card 400 can also be used to create several additional playing opportunities as well. For example, the lottery draw can be conducted to randomly select 5 player indicia 417 in the grid of player indicia area 415 using the row identifiers 440 and column identifiers 445. A win is created if the five randomly selected player indicia 417 create a “hand” as is known in the game of poker such as, for example, a royal flush, straight flush, full house, etc. Additionally, in still another exemplary embodiment of the present invention, the lottery draw can be continued until at least one of the game cards 400 registered for the drawing has a double straight flush (e.g., straight flushes in two different suits) using the cards in the selected player indicia 417.

Multiple other variations of card 400 fall within the scope of the present invention. For example, player indicia 417 are not limited to traditional playing cards. Instead, other indicia may be used such as numbers, letters, the faces of dice, moves on a game board, etc. Different grid sizes may be applied for player indicia area 415. A lottery drawing using card 400 may be conducted with a limited number of draws or may continue until a winner or a predetermined number of winners is created. One of skill in the art, using the teachings disclosed herein, will understand that the exemplary embodiment of the present invention using card 400 may be used to create multiple variations within the scope of the present invention. Regardless, the game demonstrated with card 400 may be combined with the previously described methods as discussed above (e.g., with card 200) to provide a more interactive lottery game. For example, as with game card 200, an interactive display using features such as that described with regard to display 250 may be created for use in revealing the results of the lottery drawing to the player who entered game card 400.

Although preferred embodiments of the invention have been disclosed in the foregoing specification, it will be understood by those skilled in the art using the teachings disclosed herein that many modifications and other embodiments are within the scope of the present invention.

What is claimed is:

1. A method for increasing player interaction in a game, the method comprising the steps of:
providing at least one game card to a player;
conducting a plurality of lottery drawings at different times with each drawing being suitable for play with the game card;
allowing the player to select from the plurality of lottery drawings a particular lottery drawing in which the game card will be played; and
revealing to the player the results of the particular lottery drawing selected by the player.

2. A method for increasing player interaction in a game as in claim 1, wherein said revealing step occurs about the same time as the particular lottery drawing selected by the player is conducted.

3. A method for increasing player interaction in a game as in claim 1, wherein said revealing step occurs after the particular lottery drawing selected by the player has been conducted and wherein at a time chosen by the player.

4. A method for increasing player interaction in a game as in claim 3, wherein the player is allowed to control the pace at which the results of the particular lottery drawing are reported to the player during said revealing step.

5. A method for increasing player interaction in a game as in claim 1, wherein the game card comprises an instant win portion that can be played upon purchase of the game card.

6. A method for increasing player interaction in a game as in claim 5, wherein the game card comprises a lottery-dependent portion that the player can play only in conjunction with said revealing step.

7. A method for increasing player interaction in a game as in claim 6, wherein the instant win portion and the lottery-dependent portion must be combined to determine the game results for the player.

8. A method for increasing player interaction in a game as in claim 1, wherein said revealing step comprises transmitting the results of the particular lottery drawing to the player over a computer network.

9. A method for increasing player interaction in a game as in claim 1, wherein multiple other players are allowed to participate in each drawing and wherein the total number of participating players is reported to the player in said revealing step.

10. A method for increasing player interaction in a game as in claim 9, wherein the size of potential winnings available to the player is determined in part on the number of the other players.

11. A method for increasing player interaction in a game as in claim 1, wherein information regarding wins by other players is reported to the player.

12. A method for increasing player interaction in a game as in claim 1, wherein the player is permitted to select more than one drawing in which the game card will be played.

13. A method for increasing player interaction in a game as in claim 1, wherein the game card comprises a plurality of game indicia and wherein said revealing step comprises displaying the plurality of game indicia to the player.

14. A method for increasing player interaction in a game as in claim 1, wherein said step of allowing the player to select from the plurality of lottery drawings occurs at the point of sale of the game card.

15. A method for increasing player interaction in a game as in claim 1, wherein a plurality of game cards are provided to the player in said providing step, and wherein the player is permitted to enter more than one game card in the lottery drawing selected by the player in said allowing step.

16. A method for increasing player interaction in a game as in claim 1, further comprising the steps of:
permitting the player to enter more than one game card in the lottery drawing selected by the player in said allowing step, wherein each game card comprises a plurality of game indicia; and
allowing the player to view simultaneously the plurality of game indicia of more than one entered game card during said revealing step.

17. A method for increasing player interaction in a game as in claim 1, further comprising the steps of:
permitting the player to enter more than one game card in the lottery drawing selected by the player in said allowing step, wherein each game card comprises a plurality of game indicia; and
allowing the player to selectively view the plurality of game indicia of each entered game card during said revealing step.

18. A method for increasing player interaction in a game as in claim 1, further comprising the steps of permitting the player to replay said revealing step.

19. A method for increasing player interaction in a game as in claim 1, wherein each lottery drawing is continued until at least one win has occurred among the game cards entered in such lottery drawing.

20. A method for increasing player interaction in a game as in claim 1, wherein the game card comprises:
a player indicia area containing a plurality of player indicia, the player indicia being hidden by a cover that is removable by the player;
a game indicia area containing a plurality of game indicia arranged into columns and rows so as to form a grid on the game card;
wherein the player indicia and game card indicia are configured such that the player can have an instant win by matching player indicia with game indicia to form one or more lines along a column, row, or diagonal of the grid of game indicia; and
wherein the player can also win by matching the results of the lottery drawing selected by the player with game indicia to form one or more lines along a column, row, or diagonal of the grid of game indicia.

21. A method for increasing player interaction in a game as in claim 20, wherein the player can also win by matching one or more player indicia with the results of the lottery drawing selected by the player.

22. A method for increasing player interaction in a game as in claim 20, wherein the amount of a win by the player increases based on the number of matches between the player indicia and the results of the lottery drawing selected by the player.

23. A method for increasing player interaction in a game as in claim 20, wherein the amount of a win by the player increases based on the number of lines formed along a column, row, or diagonal of the grid of game indicia.

24. A method for increasing player interaction in a game as in claim 1, wherein the game card comprises:
a player indicia area containing a plurality of player indicia, the player indicia being hidden by a cover that is removable by the player, the player indicia being selected from a deck of traditional playing cards and organized into a grid of columns and rows;
a multiplier indicia area containing at least one card selected from a deck of traditional playing cards;
wherein the player indicia are configured such that the player can have an instant win by removing the cover to reveal a poker hand within one the rows in the grid of player indicia; and
wherein the player can also win or increase the size of the win by matching the results of the lottery drawing selected by the player with the multiplier indicia.

25. A method for increasing player interaction in a game as in claim 24, wherein the game card includes row identifiers and column identifiers, and wherein the lottery drawing selected by the player further comprises at least five draws identifying positions in the grid of player indicia using the row identifiers and column identifiers, and wherein the player can also win or increase the size of the win by creating a poker hand from said at least five draws.

26. A method for increasing player interaction in a game as in claim 24, wherein the lottery drawing is continued until at least one win has occurred among the players participating in the lottery game.

27. A method for increasing player interaction in a game as in claim 1, wherein the game card is configured for allowing the player to play bingo using the results of the particular lottery drawing selected by the player.

28. A method for increasing player interaction in a game,
providing at least one game card to a player;
conducting a lottery drawing; and
reporting the results of the lottery drawing to the player;
wherein the game card comprises
a player indicia area containing a plurality of player indicia, the player indicia being hidden by a cover that is removable by the player;
a game indicia area containing a plurality of game indicia arranged into columns and rows so as to form a grid on the game card;
wherein the player indicia and game card indicia are configured such that the player can have an instant win by matching player indicia with game indicia to form one or more lines along a column, row, or diagonal of the grid of game indicia; and
wherein the player can also win by matching the results of the lottery drawing with game indicia to form one or more lines along a column, row, or diagonal of the grid of game indicia.

29. A method for increasing player interaction in a game as in claim 28, wherein the player can also win by matching one or more player indicia with the results of the lottery drawing.

30. A method for increasing player interaction in a game as in claim 28, wherein the amount of a win by the player increases based on the number of matches between the player indicia and the results of the lottery drawing.

31. A method for increasing player interaction in a game as in claim 28, wherein the amount of a win by the player increases based on the number of lines formed along a column, row, or diagonal of the grid of game indicia.

32. A method for increasing player interaction in a game,
providing at least one game card to a player;
conducting a lottery drawing; and
reporting the results of the lottery drawing to the player;
wherein the game card comprises:
a player indicia area containing a plurality of player indicia, the player indicia being hidden by a cover that is removable by the player, the player indicia being selected from a deck of traditional playing cards and organized into a grid of columns and rows;
a multiplier indicia area containing at least one card selected from a deck of traditional playing cards;
wherein the player indicia are configured such that the player can have an instant win by removing the cover to reveal a poker hand within one of the rows in the grid of player indicia; and
wherein the player can also win or increase the size of the win by matching the results of the lottery drawing with the multiplier indicia.

33. A method for increasing player interaction in a game as in claim 32, wherein the game card includes row identifiers and column identifiers, and wherein the lottery drawing further comprises at least five draws identifying positions in the grid of player indicia using the row identifiers and column identifiers, and wherein the player can also win or increase the size of the win by creating a poker hand from said at least five draws.

34. A method for increasing player interaction in a game as in claim 33, wherein the lottery drawing is continued until at least one win has occurred among the players participating in the lottery game.

35. A method for increasing player interaction in a game,
providing at least one game card to a player;
conducting a lottery drawing; and
reporting the results of the lottery drawing to the player;
wherein the game card comprises:
a player indicia area containing a plurality of player indicia, the player indicia being hidden by a cover that is removable by the player, the player indicia being selected from a set of player indicia and organized into a grid of columns and rows;
a multiplier indicia area containing at least one indicia selected from a set of multiplier indicia;
wherein the player indicia are configured such that the player can have an instant win by removing the cover to reveal a winning combination of player indicia within one of the rows in the grid of player indicia; and
wherein the player can also win or increase the size of the win by matching the results of the lottery drawing with the multiplier indicia.

36. A method for increasing player interaction in a game as in claim 35, wherein the game card includes row identifiers and column identifiers, and wherein the lottery drawing further comprises one or more draws identifying positions in the grid of player indicia using the row identifiers and column identifiers, and wherein the player can also win or increase the size of the win by creating a winning combination of player indicia from said one or more draws.
